(19) United States
(12) Patent Application Publication
(10) Pub. No.: US 2012/0204100 A1
(43) Pub. Date: Aug. 9, 2012

(54) Probabilistic Methods and Systems for Preparing Mixed-Content Document Layouts

(76) Inventor: Niranjan Damera-Venkata, Fremont, CA (US)

(21) Appl. No.: 13/501,264

(22) PCT Filed: Oct. 20, 2009
(86) PCT No.: PCT/US09/61320

§ 371 Date: Apr. 11, 2012

(51) Int. Cl. G06F 17/00

(52) U.S. Cl. 715/244

(57) ABSTRACT

Embodiments of the present invention are directed to methods and systems for preparing each page template of a mixed-content document layout. In one embodiment, a method comprises selecting a single page template (805). The template can be configured with an arrangement of one or more image fields and one or more text fields. The method includes determining constants presenting space available for displaying the one or more images and white spaces and vector representations of the one or more image and white space dimensions (806). The method also includes computing a parameter vector that substantially maximizes a probabilistic characterization of the one or more image and white space dimensions (807). The page template can be rendered so that the one or more images and white spaces are rescaled in accordance with the parameter vector and the one or more vector representations and the constants (808).

### TECHNICAL FIELD

Embodiments of the present invention relate to document layout, and in particular, to determining document template parameters for displaying various page elements based on probabilistic models of document templates.

### BACKGROUND

A mixed-content document can be organized to display a combination of text, images, headers, sidebars, or any other elements that are typically dimensioned and arranged to display information to a reader in a coherent, informative, and visually aesthetic manner. Mixed-content documents can be in printed or electronic form, and examples of mixed-content documents include articles, flyers, business cards, newsletters, website displays, brochures, single or multi page advertisements, envelopes, and magazine covers just to name a few. In order to design a layout for a mixed-content document, a document designer selects for each page of the document a number of elements, element dimensions, spacing between elements called “white space,” font size and style for text, background, colors, and an arrangement of the elements.

In recent years, advances in computing devices have accelerated the growth and development of software-based document layout design tools and, as a result, increased the efficiency with which mixed-content documents can be produced. A first type of design tool uses a set of gridlines that can be seen in the document design process but are invisible to the document reader. The gridlines are used to align elements on a page, allow for flexibility by enabling a designer to position elements within a document, and even allow a designer to extend portions of elements outside of the guidelines, depending on how much variation the designer would like to incorporate into the document layout. A second type of document layout design tool is a template. Typical design tools present a document designer with a variety of different templates to choose from for each page of the document. FIG. 1 shows an example of a template 100 for a single page of a mixed-content document. The template 100 includes two image fields 101 and 102, three text fields 104-106, and a header field 108. The text, image, and header fields are separated by white spaces. A white space is a blank region of a template separating two fields, such as white space 110 separating image field 101 from text field 105. A designer can select the template 100 from a set of other templates, input image data to fill the image fields 101 and text data to fill the text fields 104-106 and the header 108.

However, it is often the case that the dimensions of template fields are fixed making it difficult for document designers to resize images and arrange text to fill particular fields creating image and text overflows, cropping, or other unpleasant scaling issues. FIG. 2 shows the template 100 where two images, represented by dashed-line boxes 201 and 202, are selected for display in the image fields 101 and 102. As shown in the example of FIG. 2, the images 201 and 202 do not fit appropriately within the boundaries of the image fields 101 and 102. With regard to the image 201, a design tool may be configured to crop the image 201 to fit within the boundaries of the image field 101 by discarding peripheral, but visually import, portions of the image 201, or the design tool may attempt to fit the image 201 within the image field 101 by rescaling the aspect ratio of the image 201, resulting in a visually displeasing distorted image 201. Because image 202 fits within the boundaries of image field 102 with room to spare, white spaces 204 and 206 separating the image 202 from the text fields 104 and 106 exceed the size of the white spaces separating other elements in the template 100 resulting in a visually distracting uneven distribution of the elements. The design tool may attempt to correct for this problem by rescaling the aspect ratio of the image 202 to fit within the boundaries of the image field 102, also resulting in a visually displeasing distorted image 202.

Document designers and users of document-layout software continue to seek enhancements in document layout design methods and systems.

### BRIEF DESCRIPTION OF THE DRAWINGS

FIG. 1 shows an example of a template for a single page of a mixed-content document.

FIG. 2 shows the template shown in FIG. 1 with two images selected for display in the image fields.

FIG. 3A shows an exemplary representation of a first single page template with dimensions identified in accordance with embodiments of the present invention.

FIG. 3B shows vector characterization of template parameters and dimensions of an image and white spaces associated with the template shown in FIG. 3A in accordance with embodiments of the present invention.

FIG. 4A shows an exemplary representation of a second single page template with dimensions identified in accordance with embodiments of the present invention.

FIG. 4B shows vector characterization of template parameters and dimensions of images and white spaces associated with the template shown in FIG. 4A in accordance with embodiments of the present invention.

FIG. 5A shows an exemplary representation of a third single page template with dimensions identified in accordance with embodiments of the present invention.

FIG. 5B shows vector characterization of template parameters and dimensions of images and white spaces associated with the template shown in FIG. 5A in accordance with embodiments of the present invention.

FIG. 6 shows an exemplary plot of a normal distribution for three different variances in accordance with embodiments of the present invention.

FIG. 7A shows an example of a template configured in accordance with embodiments of the present invention.

FIG. 7B shows a hypothetical rescaled version of the images and white spaces of the exemplary template shown in FIG. 7A in accordance with embodiments of the present invention.

FIG. 8 shows a control-flow diagram of a method for generating document templates in accordance with embodiments of the present invention.

FIG. 9 shows a schematic representation of a computing device configured in accordance with embodiments of the present invention.

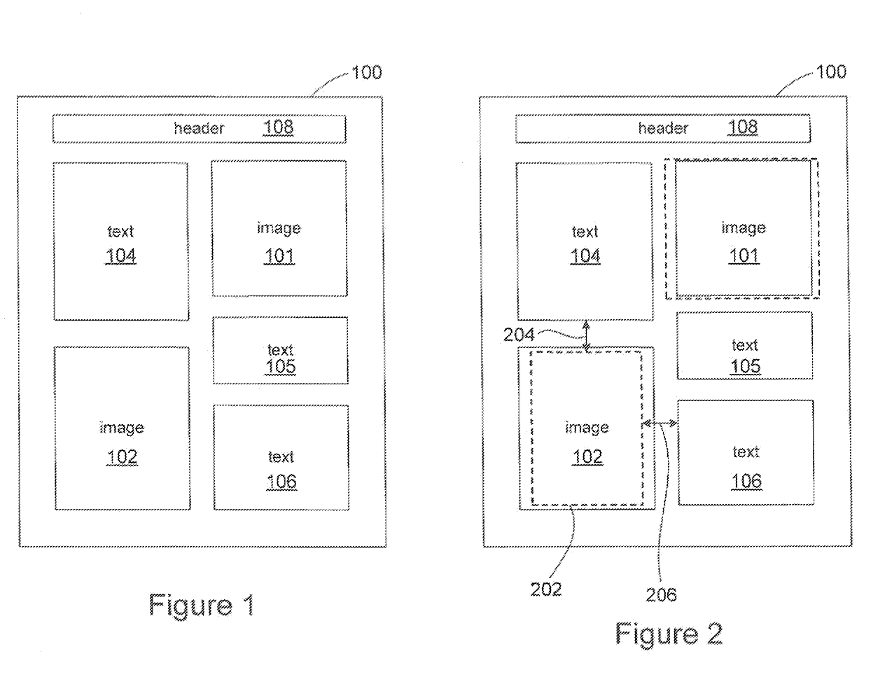

### DETAILED DESCRIPTION

Embodiments of the present invention are directed to methods and systems for preparing each page template of a mixed-content document layout. The methods and systems are based on probabilistic template models that provide a probabilistic description of element dimensions for each page template. Each template of a mixed-content document layout has an associated probabilistic description of element dimensions. In other words, the dimensional parameters, such as height and width, of each element displayed in a template have an associated uncertainty that can be selected based on prior probability distributions. Methods of the present invention are predicated on the assumption that when one observes specific elements to be arranged within a template, certain parameters for scaling the dimensions of the elements within the template become more likely. Embodiments of the present invention provide a closed form description of the probability distribution of element dimensions from which the template parameters can be estimated. The set of parameters associated with each template can be determined based on given observed data so that the probability is maximized.

Embodiments of the present invention are mathematical in nature and, for this reason, are described below with reference to numerous equations and graphical illustrations. In particular, embodiments of the present invention are based on Bayes' Theorem from the probability theory branch of mathematics. Although mathematical expressions alone may be sufficient to fully describe and characterize embodiments of the present invention to those skilled in the art, the more graphical, problem oriented examples, and control-flow-diagram approaches included in the following discussion are intended to illustrate embodiments of the present invention so that the present invention may be accessible to readers with various backgrounds. In order to assist in understanding descriptions of various embodiments of the present invention, an overview of Bayes' Theorem is provided in a first subsection, template parameters are introduced in a second subsection, and probabilistic template models based on Bayes' Theorem for determining template parameters are provided in a third subsection.

### An Overview of Bayes' Theorem and Related Concepts from Probability Theory

Readers already familiar with Bayes' Theorem and other related concepts from probability theory can skip this subsection and proceed to the next subsection titled Template Parameters. This subsection is intended to provide readers who are unfamiliar with Bayes' Theorem a basis for understanding relevant terminology, notation, and provide a basis for understanding how Bayes' Theorem is used to determine document template parameters as described below. For the sake of simplicity, Bayes' theorem and related topics are described below with reference to sample spaces with discrete events, but one skilled in the art will recognize that these concepts can be extended to sample spaces with continuous distributions of events.

A description of probability begins with a sample space S, which is the mathematical counterpart of an experiment and mathematically serves as a universal set for all possible outcomes of an experiment. For example, a discrete sample space can be composed of all the possible outcomes of tossing a fair coin two times and is represented by:

S={HH,HT,TH,TT}

where H represents the outcome heads, and T represents the outcome tails. An event is a set of outcomes, or a subset of a sample space, to which a probability is assigned. A simple event is a single element of the sample space S, such as the event “both coins are tails” TT, or an event can be a larger subset of S, such as the event “at least one coin toss is tails” comprising the three simple events HT, TH, and TT.

The probability of an event E, denoted by P(E), satisfies the condition 0≦P(E)≦1 and is the sum of the probabilities associated with the simple events comprising the event E. For example, the probability of observing each of the simple events of the set S, representing the outcomes of tossing a fair coin two times, is ¼. The probability of the event “at least one coin is heads” is ¾ (i.e., ¼+¼+¼, which are the probabilities of the simple events HH, HT, and TH, respectively).

Bayes' Theorem provides a formula for calculating conditional probabilities. A conditional probability is the probability of the occurrence of some event A, based on the occurrence of a different event B. Conditional probability can be defined by the following equation:

$$P ( A \vert B ) = \frac{P ( A ⋂ B )}{P ( B )}$$

where P(A|B) is read as “the probability of the event A, given the occurrence of the event B,”

P(A∩B) is read as “the probability of the events A and B both occurring,” and

P(B) is simple the probability of the event B occurring regardless of whether or not the event A occurs.

For an example of conditional probabilities, consider a club with four male and five female charter members that elects two women and three men to membership. From the total of 14 members, one person is selected at random, and suppose it is known that the person selected is a charter member. Now consider the question of what is the probability the person selected is male? In other words, given that we already know the person selected is a charter member, what is the probability the person selected at random is male? In terms of the conditional probability, B is the event “the person selected is a charter member,” and A is the event “the person selected is male.” According to the formula for conditional probability:

P(B)=9/14, and

P(A∩B)=7/14

Thus, the probability of the person selected at random is male given that the person selected is a charter member is:

$$P ( A \vert B ) = \frac{P ( A ⋂ B )}{P ( B )} = \frac{7 / 14}{9 / 14} = \frac{7}{9}$$

Bayes' theorem relates the conditional probability of the event A given the event B to the probability of the event B given the event A. In other words, Bayes' theorem relates the conditional probabilities P(A|B) and P(B|A) in a single mathematical expression as follows:

$$P ( A \vert B ) = \frac{P ( B \vert A ) P ( A )}{P ( B )}$$

P(A) is a prior probability of the event A. It is called the “prior” because it does not take into account the occurrence of the event B. P(B|A) is the conditional probability of observing the event B given the observation of the event A. P(A|B) is the conditional probability of observing the event A given the observation of the event B. It is called the “posterior” because it depends from, or is observed after, the occurrence of the event B. P(B) is a prior probability of the event B, and can serve as a normalizing constant.

For an exemplary application of Bayes' theorem consider two urns containing colored balls as specified in Table I:

TABLE I

| Urn | Red | Yellow | Blue |
|---|---|---|---|
| 1 | 3 | 4 | 2 |
| 2 | 1 | 2 | 3 |

Suppose one of the urns is selected at random and a blue ball is removed. Bayes' theorem can be used to determine the probability the ball came from urn 1. Let B denote the event “ball selected is blue.” To account for the occurrence of B there are two hypotheses: A₁ is the event urn 1 is selected, and A₂ is the event urn 2 is selected. Because the urn is selected at random,

P(A₁)=P(A₂)=1/2

Based on the entries in Table I, conditional probabilities also give:

P(B|A₁)=2/9, and

P(B|A₂)=3/6

The probability of the event “ball selected is blue,” regardless of which urn is selected, is

$$\begin{matrix}P ( B ) = P ( B \vert {A}_{1} ) P ( {A}_{1} ) + P ( B \vert {A}_{2} ) P ( {A}_{2} ) \\ = ( 2 / 9 ) ( 1 / 2 ) + ( 3 / 6 ) ( 1 / 2 ) \\ = 13 / 27\end{matrix}$$

Thus, according to Bayes' theorem, the probability the blue ball came from urn 1 is given by:

$$P ( {A}_{i} \vert B ) = \frac{P ( B \vert {A}_{1} ) P ( {A}_{1} )}{P ( B )} = \frac{( 2 / 9 ) ( 1 / 2 )}{13 / 27} = \frac{3}{13}$$

### Template Parameters

In this subsection, template parameters used to obtain dimensions of image fields and white spaces of a document template are described with reference to just three exemplary document templates. The three examples described below are not intended to be exhaustive of the nearly limitless possible dimensions and arrangements of template elements. Instead, the examples described in this subsection are intended to merely provide a basic understanding of how the dimensions of elements of a template can be characterized in accordance with embodiments of the present invention, and are intended to introduce the reader to the terminology and notation used to represent template parameters and dimensions of document templates. Note that template parameters are not used to change the dimensions of the text fields or the overall dimensions of the templates. Template parameters are formally determined using probabilistic methods and systems described below in the subsequent subsection.

In preparing a document layout, document designers typically select a style sheet in order to determine the document's overall appearance. The style sheet may include (1) a typeface, character size, and colors for headings, text, and background; (2) format for how front matter, such as preface, figure list, and title page should appear; (3) format for how sections can be arranged in terms of space and number of column's, line spacing, margin widths on all sides, and spacing between headings just to name a few; and (4) any boilerplate content included on certain pages, such as copyright statements. The style sheet typically applies to the entire document. As necessary, specific elements of the style sheet may be overridden for particular sections of the document.

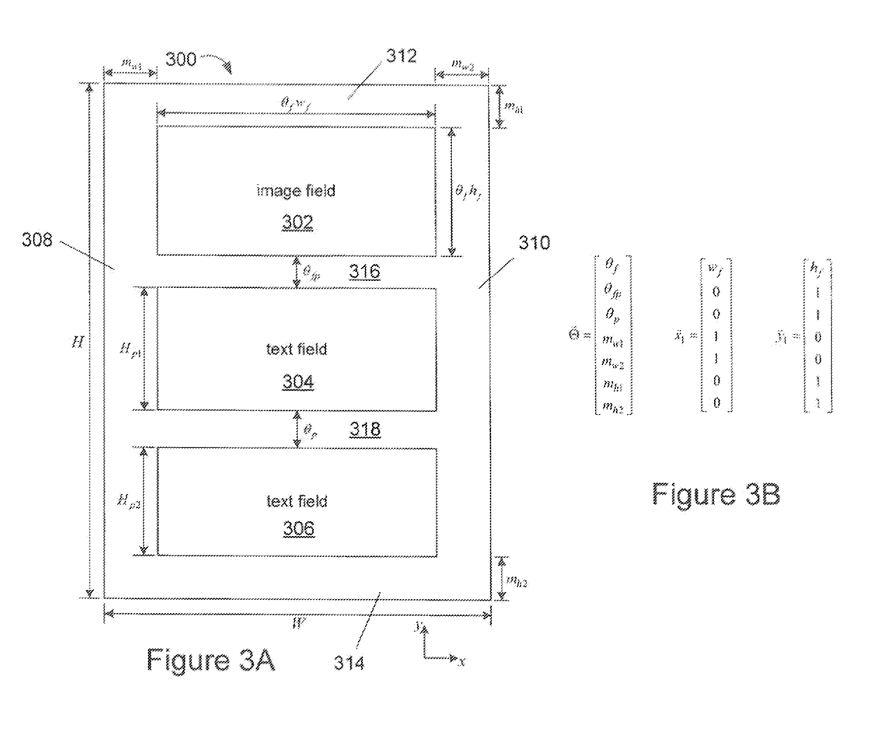

Document templates represent the arrangement elements for displaying text and images for each page of the document. FIG. 3A shows an exemplary representation of a first single page template 300 with dimensions identified in accordance with embodiments of the present invention. Template 300 includes an image field 302, a first text field 304, and a second text field 306. The width and height of the template 300 are fixed values represented by constants W and H, respectively. Widths of margins 308 and 310, m_{w1} and m_{w2}, extending in the y-direction are variable, and widths of top and bottom margins 312 and 314, mₕ₁ and mₕ₂, extending in the x-direction are variable. Note that templates may include a constraint on the minimum margin width below which the margins cannot be reduced. The dimensions of text fields 304 and 306 are also fixed with the heights denoted by Hₚ₁ and Hₚ₂, respectively. As shown in the example of FIG. 3A, the scaled height and width dimensions of an image placed in the image field 302 are represented by θ_{f}h_{f} and θ_{f}w_{f}, respectively, where h_{f} and w_{f} represent the height and width of the image, and θ_{f} is a single template parameter used to scale both the height h_{f} and width w_{f} of the image. Note that using a single scale factor θ_{f} to adjust both the height and width of an image reduces image distortion, which is normally associated with adjusting the aspect ratio of an image in order to fit the image within an image field. FIG. 3A also includes a template parameter θ_{fp} that scales the width of the white space 316, and a template parameter θₚ that scales the width of the white space 318.

The template parameters and dimensions of an image and white space associated with the template 300 can be characterized by vectors shown in FIG. 3B in accordance with embodiments of the present invention. The parameter vector Θ̅ includes three template parameters θ_{f}, θ_{fp}, and θₚ associated with adjusting the dimensions of the image field 302 and the white spaces 316 and 318 and includes the variable margin values m_{w1}, m_{w2}, mₕ₁, and mₕ₂. Vector elements of vector x̅₁ represent dimensions of the image displayed in the image field 302 and margins in the x-direction, and vector elements of vector y̅₁ represent dimensions of the image, white spaces, and margins in the y-direction. The vector elements of the vectors x̅₁ and y̅₁ are selected to correspond to the template parameters of the parameter vector Θ̅ as follows. Because both the width w_{f} and the height h_{f} of the image are scaled by the same parameter θ_{f}, as described above, the first vector elements of x̅₁ and y̅₁ are w_{f} and h_{f}, respectively. The only other dimensions varied in the template 300 are the widths of the white spaces 316 and 318, which are varied in the y-direction, and the margins which are varied in the x- and y-directions. For x̅₁, the two vector elements corresponding to the parameters θ_{fp} and θₚ are “0,” the two vector elements corresponding to the margins m_{w1} and m_{w2} are “1,” and the two vector elements corresponding to the margins mₕ₁ and mₕ₂ are “0.” For y̅₁, the two vector elements corresponding to the parameters θ_{fp} and θₚ are “1,” the two vector elements corresponding to the margins m_{w1} and m_{w2} are “0,” and the two vector elements corresponding to the margins mₕ₁ and mₕ₂ are “1.”

The vector elements of x̅₁ and y̅₁ are arranged to correspond to the parameters of the vector Θ̅ in order to satisfy the following condition in the x-direction:

Θ̅^{T} x̅₁−W₁=0

and the following condition in the y-direction:

Θ̅^{T} y̅₁−H₁=0

where

Θ̅^{T} x̅₁=θ_{f}w_{f}+m_{w1}+m_{w2} is the scaled width of the image displayed in the image field 302;

W₁=W is a variable corresponding to the space available to the image displayed in the image field 302 in the x-direction;

Θ̅^{T} y̅₁=θ_{f}h_{f}+θ_{fp}+θₚ+mₕ₁+mₕ₂ is the sum of the scaled height of the image displayed in the image field 302 and the parameters associated with scaling the white spaces 316 and 318; and

H₁=H−Hₚ₁−Hₚ₂ is a variable corresponding to the space available for the image displayed in the image field 302 and the widths of the white spaces 316 and 318 in the y-direction.

Probabilistic methods based on Bayes' theorem described below can be used to determine the template parameters so that the conditions Θ̅^{T} x̅₁−W₁=0 and Θ̅^{T} y̅₁−H₁=0 are satisfied.

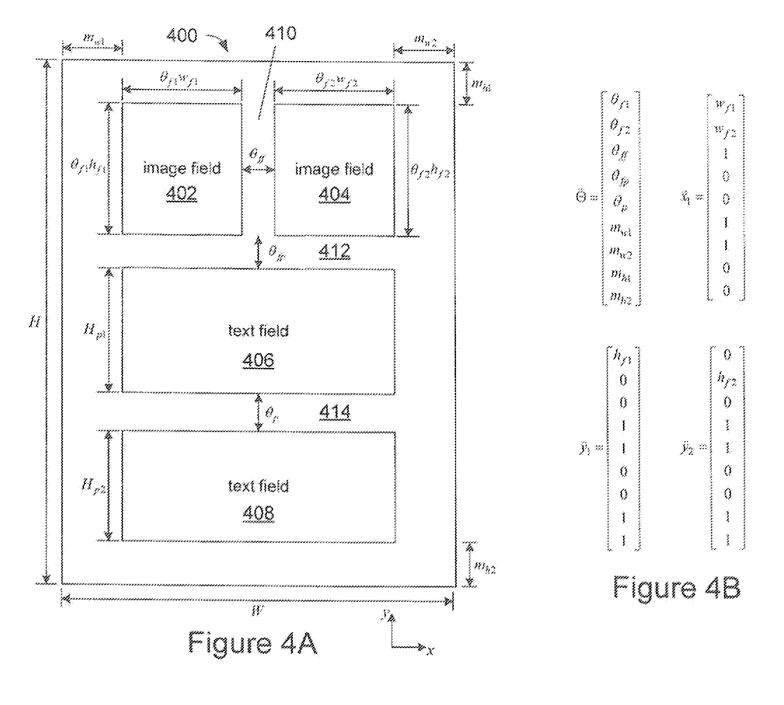

FIG. 4A shows an exemplary representation of a second single page template 400 with dimensions identified in accordance with embodiments of the present invention. Template 400 includes a first image field 402, a second image field 404, a first text field 406, and a second text field 408. Like the template 300 described above, the template 400 width W and height H are fixed and side margins m_{w1} and m_{w2} extending in the y-direction and top and bottom margins mₕ₁ and mₕ₂ extending in the x-direction are variable but are subject to minimum value constraints. The dimensions of text fields 404 and 406 are also fixed with the heights denoted by Hₚ₁ and Hₚ₂, respectively. As shown in the example of FIG. 4A, the scaled height and width dimensions of an image placed in the image field 402 are represented by θ_{f1}h_{f1} and θ_{f1}w_{f1}, respectively, where h_{f1} and w_{f1} represent the height and width of the image, and θ_{f1} is a single template parameter used to scale both the height h_{f1} and width w_{f1} of the image. The scaled height and width dimensions of an image displayed in the image field 404 are represented by θ_{f2}h_{f2} and θ_{f2}w_{f2}, respectively, where h_{f2} and w_{f2} represent the height and width of the image, and θ_{f2} is a single template parameter used to scale both the height h_{f2} and width w_{f2} of the image. FIG. 4A also includes a template parameter that scales the width of the white space 410, a template parameter θ_{fp} that scales the width of the white space 412, and a template parameter θₚ that scales the width of the white space 414.

The template parameters and dimensions of images and white spaces associated with the template 400 are characterized by vectors shown in FIG. 4B in accordance with embodiments of the present invention. The parameter vector Θ̅ includes the five template parameters θ_{f1}, θ_{f2}, θ_{ff} θ_{fp}, and θₚ and the variable margin values m_{w1}, m_{w2}, mₕ₁, and mₕ₂. The changes to the template 400 in the x-direction are the widths of the images displayed in the image fields 402 and 404 and the width of the white space 410, which are characterized by a single vector x̅₁. As shown in FIG. 4B, the first two vector elements of x̅₁ are the widths w_{f1} and w_{f2} of the images displayed in the image fields 402 and 404 in the x-direction and correspond to the first two vector elements of the parameter vector Θ̅. The third vector element of x̅₁ is “1” which accounts for the width of the white space 410 and corresponds to the third vector element of the parameter vector Θ̅. The fourth and fifth vector elements of x̅₁ are “0,” which correspond to the fourth and fifth the vector elements of Θ̅. The remaining four vector elements of x̅₁ corresponding to the margins m_{w1} and m_{w2} are “1” and corresponding to the margins mₕ₁ and mₕ₂ are “0.”

On the other hand, changes to the template 400 in the y-direction are characterized by two vectors y̅₁ and y̅₂, each vector accounting for changes in the height of two different images displayed in the image fields 402 and 404 and the white spaces 412 and 414. As shown in FIG. 4B, the first vector element of y̅₁ is the height of the image displayed in the image field 402 and corresponds to the first vector element of the parameter vector Θ̅. The second vector element of y̅₂ is the height of the image displayed in the image field 404 and corresponds to the second term of the parameter vector Θ̅. The fourth and fifth vector elements of y̅₁ and y̅₂ are “1” which account for the widths of the white spaces 412 and 414 and correspond to the fourth and fifth vector elements of the parameter vector Θ̅. The “0” vector elements of y̅₁ and y̅₂ correspond to the parameters that scale dimensions in the x-direction. The remaining four vector elements of y̅₁ and y̅₂ corresponding to the margins m_{w1} and m_{w2} are “0” and corresponding to the margins mₕ₁ and mₕ₂ are “1.”

As described above with reference to FIG. 4B, the vector elements of x̅₁, y̅₁, and y̅₂ are arranged to correspond to the parameters of the vector Θ̅ to satisfy the following condition in the x-direction:

Θ̅^{T} x̅₁−W₁=0

and the following conditions in the y-direction:

Θ̅^{T} y̅₁−H₁=0

Θ̅^{T} y̅₂−H₂=0

where

Θ̅^{T} x̅₁=θ_{f1}w_{f1}+θ_{f2}w_{f2}+θ_{ff}+m_{w1}+m_{w2} is the scaled width of the images displayed in the image fields 402 and 404 and the width of the white space 410;

W₁=W is a variable corresponding to the space available for the images displayed in the image fields 402 and 404 and the white space 410 in the x-direction;

Θ̅^{T} y̅₁=θ_{f1}h_{f1}+θ_{fp}+θₚ+mₕ₁+mₕ₂ is the sum of the scaled height of the image displayed in the image field 402 and the parameters associated with scaling the white spaces 412 and 414;

Θ̅^{T} y̅₂=θ_{f2}h_{f2}+θ_{fp}+θₚ+mₕ₁+mₕ₂ is the sum of the scaled height of the image displayed in the image field 404 and the parameters associated with scaling the white spaces 412 and 414,

H₁=H−Hₚ₁−Hₚ₂ is a first variable corresponding to the space available for the image displayed in the image field 402 and the widths of the white spaces 412 and 414 in the y-direction; and

H₂=H₁ is a second variable corresponding to the space available for the image displayed in the image field 404 and the widths of the white spaces 412 and 414 in the y-direction.

Probabilistic methods based on Bayes' theorem described below can be used to determine the template parameters so that the conditions Θ̅^{T} x̅₁−W₁=0, Θ̅^{T} y̅₁−H₁=0 and Θ̅^{T} y̅₂−H₂=0 are satisfied.

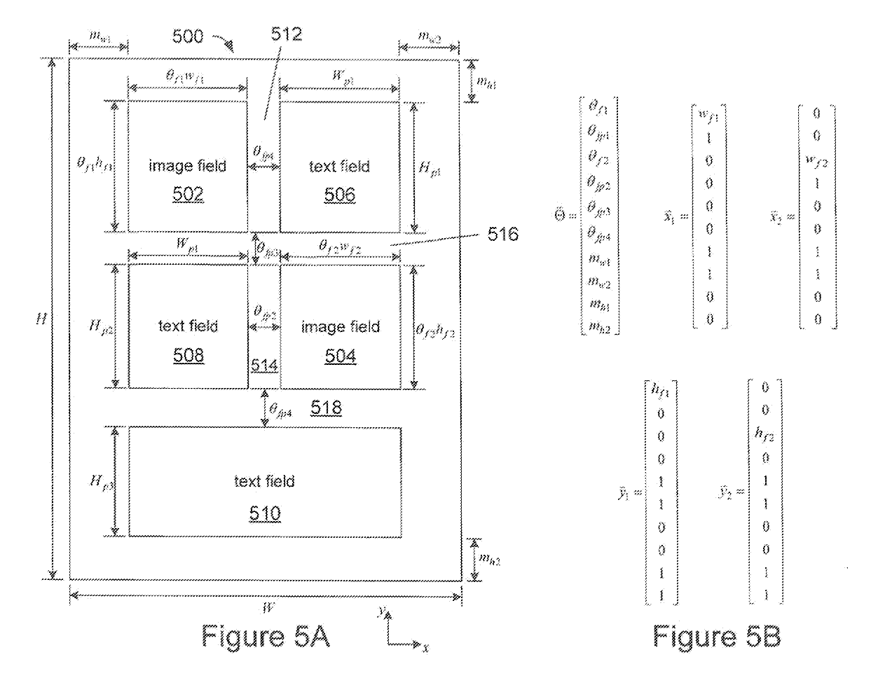

FIG. 5A shows an exemplary representation of a single page template 500 with dimensions identified in accordance with embodiments of the present invention. Template 500 includes a first image field 502, a second image field 504, a first text field 506, a second text field 508, and a third text field 510. Like the templates 300 and 400 described above, the template width W and height H are fixed and side margins m_{w1} and m_{w2} extending in the y-direction and top and bottom margins mₕ₁ and mₕ₂ extending in the x-direction are variable, but are subject to minimum value constraints. The dimensions of text fields 506, 508, and 510 are also fixed with the heights denoted by Hₚ₁, Hₚ₂, and Hₚ₃, respectively, and the widths of the text fields 506 and 508 denoted by Wₚ₁ and Wₚ₂, respectively. As shown in the example of FIG. 5A, the scaled height and width dimensions of an image displayed in the image field 502 are represented by θ_{f1}h_{f1} and θ_{f1}w_{f1}, respectively, where h_{f1} and w_{f1} represent the height and width of the image, and θ_{f1} is a single template parameter used to scale both the height h_{f1} and width w_{f1} of the image. The scaled height and width dimensions of an image displayed in the image field 504 are represented by θ_{f2}h_{f2} and θ_{f2}w_{f2}, respectively, where h_{f2} and w_{f2} represent the height and width of the image, and θ_{f2} is a single template parameter used to scale both the height h_{f2} and width w_{f2} of the image. FIG. 5A also includes a template parameter θ_{fp1} that scales the width of the white space 512, a template parameter θ_{fp2} that scales the width of the white space 514, a template parameter θ_{fp3} that scales the width of the white space 516, and a template parameter θ_{fp4} that scales the width of white space 518.

The template parameters and dimensions of images and white spaces associated with the template 500 are characterized by vectors shown in FIG. 5B in accordance with embodiments of the present invention. The parameter vector Θ̅ includes the six template parameters θ_{f1}, θ_{fp1} θ_{f2}, θ_{fp2} θ_{fp3}, and θ_{fp4} and the variable margin values m_{w1}, m_{w2}, mₕ₁, and mₕ₂. The changes to the template 500 in the x-direction include the width of the image displayed in the image field 502 and the width of the white space 512, and separate changes in the width of the image displayed in the image field 504 and the width of the white space 514. These changes are characterized by vectors x̅₁ and x̅₂. As shown in FIG. 5B, the first vector element of x̅₁ is the width w_{f1} and the second vector element is “1” which correspond to first two vector elements of the parameter vector Θ̅. The third vector element of x̅₂ is the width w_{f2} and the fourth vector element is “1” which correspond to first third and fourth vector elements of the parameter vector Θ̅. The fifth and sixth vector elements of x̅₁ and x̅₂ corresponding to white spaces that scale dimensions in the y-direction are “0.” The remaining four vector elements of x̅₁ and x̅₂ corresponding to the margins m_{w1} and m_{w2} are “1” and corresponding to the margins mₕ₁ and mₕ₂ are “0.”

On the other hand, changes to the template 500 in the y-direction are also characterized by two vectors y̅₁ and y̅₂. As shown in FIG. 5B, the first vector element of y̅₁ is the height of the image displayed in the image field 502 and corresponds to the first vector element of the parameter vector Θ̅. The third vector element of y̅₂ is the height of the image displayed in the image field 504 and corresponds to the third term of the parameter vector Θ̅. The fifth and sixth vector elements of y̅₁ and y̅₂ are “1” which account for the widths of the white spaces 516 and 518 and correspond to the fifth and sixth vector elements of the parameter vector Θ̅. The vector elements of y̅₁ and y̅₂ corresponding to white space that scale in the x-direction are “0.” The remaining four vector elements of y̅₁ and y̅₂ corresponding to the margins m_{w1} and m_{w2} are “0” and corresponding to the margins mₕ₁ and mₕ₂ are “1.”

As described above with reference to FIG. 5B, the vector elements of x̅₁, x̅₂, y̅₁, and y̅₂ are arranged to correspond to the parameters of the vector Θ̅ in order to satisfy the following conditions in the x-direction:

Θ̅^{T} x̅₁−W₁=0

Θ̅^{T} x̅₂−W₂=0

and satisfy the following conditions in the y-direction:

Θ̅^{T} y̅₁−H₁=0

Θ̅^{T} y̅₂−H₂=0

where

Θ̅^{T} x̅₁=θ_{f1}w_{f1}+θ_{fp1}+m_{w1}+m_{w2} is the scaled width of the images displayed in the image fields 502 and the width of the white space 512;

W₁=W−Wₚ₁ is a first variable corresponding to the space available for displaying an image into the image field 502 and the width of the white space 512 in the x-direction;

Θ̅^{T} x̅₂=θ_{f2}w_{f2}+θ_{fp2}+mₕ₁+mₕ₂ is the scaled width of the image displayed in the image field 504 and the width of the white space 514;

W₂=W−Wₚ₂ is a second variable corresponding to the space available for displaying an image into the image field 504 and width of the white space 514 in the x-direction;

Θ̅^{T} y̅₁=θ_{f1}h_{f1}+θ_{fp3}+θ_{fp4}+mₕ₁+mₕ₂ is the sum of the scaled height of the image displayed in the image field 402 and the parameters associated with scaling the white spaces 412 and 414;

H₁=H−Hₚ₂−Hₚ₃ is a first variable corresponding to the space available to the height of the image displayed in image field 502 and the widths of the white spaces 516 and 518 in the y-direction;

Θ̅^{T} y̅₂=θ_{f2}h_{f2}+θ_{fp3}+θ_{fp4}+mₕ₁+mₕ₂ is the sum of the scaled height of the image displayed in the image field 404 and the parameters associated with scaling the white spaces 412 and 414; and

H₂=H−Hₚ₁−Hₚ₃ is a second variable corresponding to the space available to the height of the image displayed in image field 504 and the widths of the white spaces 516 and 518 in the y-direction.

Probabilistic methods based on Bayes' theorem described below can be used to determine the template parameters so that the conditions Θ̅^{T} x̅₁−W₁=0, Θ̅^{T} x̅₂−W₂=0, Θ̅^{T} y̅₁−H₁=0, and Θ̅^{T} y̅₂−H₂=0 are satisfied.

Note that the templates 300, 400, and 500 are examples representing how the number of constants associated with the space available in the x-direction Wᵢ and corresponding vectors x̅ᵢ, and the number of constants associated with the space available in the y-direction Hⱼ and corresponding vectors y̅ⱼ, can be determined by the number of image fields and how the image fields are arranged within the template. For example, for the template 300, shown in FIGS. 3A-3B, the template 300 is configured with a single image field resulting in a single constant W₁ and corresponding vector x̅₁ and a single constant H₁ and corresponding vector y̅₁. However, when the number of image fields exceeds one, the arrangement of image fields can create more that one row and/or column, and thus, the number of constants representing the space available in the x- and y-directions can be different, depending on how the image fields are arranged. For example, for the template 400, shown in FIG. 4A-4B, the image fields 402 and 404 create a single row in the x-direction so that the space available for adjusting the images placed in the image fields 402 and 404 in the x-direction can be accounted for with a single constant W₁ and the widths of the images and white space 410 can be accounted for in a single associated vector x̅₁. On the other hand, as shown in FIG. 4A, the image fields 402 and 404 also create two different columns in the y-direction. Thus, the space available for separately adjusting the images placed in the image fields 402 and 404 in the y-direction can be accounted for with two different constants H₁ and H₂ and associated vectors y̅₁ and y̅₂. The template 500, shown in FIGS. 5A-5B, represents a case where the image fields 502 and 504 create two different rows in the x-direction and two different columns in the y-direction. Thus, in the x-direction, the space available for separately adjusting the images placed in the image fields 502 and 504 and the white spaces 512 and 514 can be accounted for with two different constants W₁ and W₂ and associated vectors x̅₁ and x̅₂, and in the y-direction, the space available for separately adjusting the same images and the white spaces 516 and 516 can be accounted for with two different constants H₁ and H₂ and associated vectors y̅₁ and y̅₂.

In summary, a template is defined for a given number of images. In particular, for a template configured with m rows and n columns of image fields, there are W₁, W₂, . . . , Wₘ constants and corresponding vectors x̅₁, x̅₂, . . . , x̅ₘ associated with the m rows, and there are H₁, H₂, . . . , Hₙ constants and corresponding vectors y̅₁, y̅₂, . . . , y̅ₙ associated with the n columns.

### Probabilistic Methods and Systems for Determining Document Template Parameters

Methods of the present invention can be used to prepare each page template of a mixed-content document layout. The methods are based on probabilistic template models that provide a probabilistic description of element dimensions for each page template. In particular, each template of a mixed-content document layout has an associated probabilistic description of element dimensions. In other words, element dimensions, such as height and width, have an associated uncertainty that can be selected based on prior probability distributions. Methods of the present invention are based on the assumption that when one observes specific elements to be arranged within a template, template parameters can be determined and used to scale the dimensions of the elements within the template where certain template parameters are more likely to be observed than others.

Methods of the present invention can be used to obtain a closed form description of the parameter vector Θ̅. This closed form description can be obtained by considering the relationship between dimensions of elements of a template with m rows of image fields and n columns of image fields and the corresponding parameter vector Θ̅ in terms of Bayes' Theorem from probability theory as follows:

P( Θ̅| W̅, H̅, x̅, y̅) ∝ P( W̅, H̅, x̅, y̅| Θ̅)P( Θ̅) Equation (1)

where

W̅=[W₁,W₂, . . . , Wₘ]^{T},

H̅=[H₁,H₂, . . . , Hₙ]^{T},

x̅=[ x̅₁, x̅₂, . . . , x̅ₘ]^{T},

y̅=[ y̅₁, y̅₂, . . . , y̅ₙ]^{T}, and

the exponent T represents the transpose from matrix theory.

Vector notation is used to succinctly represent template constants Wᵢ and corresponding vectors x̅ᵢ associated with the m rows and template constants Hⱼ and corresponding vectors y̅ⱼ associated with the n columns of the template.

Equation (1) is in the form of Bayes' Theorem but with the normalizing probability P( W̅, H̅, x̅, y̅) excluded from the denominator of the right-hand side of equation (1) (e.g., see the definition of Bayes' Theorem provided in the subsection titled An Overview of Bayes' Theorem and Related Concepts from Probability Theory). As demonstrated below, the normalizing probability P( W̅, H̅, x̅, y̅) does not contribute to determining the template parameters Θ̅ that maximize the posterior probability P( Θ̅| W̅, H̅, x̅, y̅), and for this reason P( W̅, H̅, x̅, y̅) can be excluded from the denominator of the right-hand side of equation (1).

In equation (1), the term P( Θ̅) is the prior probability associated with the parameter vector Θ̅ and does not take into account the occurrence of an event composed of W̅, H̅, x̅, and y̅. In certain embodiments, the prior probability can be characterized by a normal, or Gaussian, probability distribution given by:

$$\begin{matrix}P ( \vec{Θ} ) \approx N ( \vec{Θ} \vert {\overline{Θ}}_{1} , {Λ}_{1}^{- 1} ) N ( \vec{Θ} \vert {\overline{Θ}}_{2} , {Λ}_{2}^{- 1} ) \\ ∝ exp ( {( {\overline{Θ}}_{1} - \vec{Θ} )}^{T} \frac{{Λ}_{1}}{2} ( {\overline{Θ}}_{1} - \vec{Θ} ) ) \\ exp ( {( {\vec{Θ}}_{2} - \vec{Θ} )}^{T} \frac{{Λ}_{2}}{2} ( {\overline{Θ}}_{2} - \vec{Θ} ) )\end{matrix}$$

where

Θ̅₁ is a vector composed of independent mean values for the parameters set by a user;

Λ₁ is a diagonal matrix of variances for the independent parameters set by the user;

Λ₂=C^{T}Δ^{T}ΔC is a non-diagonal covariance matrix for dependent parameters; and

Θ̅₂=Λ⁻¹C^{T}Δ^{T}Δ d̅ is a vector composed of dependent mean values for the parameters.

The matrix C and the vector d̅ characterize the linear relationships between the parameters of the parameter vector Θ̅ given by C Θ̅= d̅ and Δ is a covariance precision matrix. For example, consider the template 300 described above with reference to FIGS. 3A-3B. Suppose hypothetically the parameters of the parameter vector Θ̅ represented in FIG. 3B are linearly related by the following equations:

0.2θ_{f}+3.1θₚ=−1.4, and

1.8θ_{f}−0.7θ_{fp}+1.1θₚ=3.1

Thus, in matrix notation, these two equations can be represented as follows:

$$C \vec{Θ} = [ \begin{matrix}0.2 & 0 & 3.1 \\ 1.8 & - 0.7 & 1.1\end{matrix} ] [ \begin{matrix}{θ}_{f} \\ {θ}_{fp} \\ {θ}_{p}\end{matrix} ] = [ \begin{matrix}- 1.4 \\ 3.1\end{matrix} ] = \overline{d}$$

Returning to equation (1), the term P( W̅, H̅, x̅, y̅| Θ̅) is the conditional probability of an event composed of W̅, H̅, x̅, and y̅, given the occurrence of the parameters of the parameter vector Θ̅. In certain embodiments, the term P( W̅, H̅, x̅, y̅| Θ̅) can be characterized as follows:

$$P ( \vec{W} , \vec{H} , \vec{x} , \vec{y} \vert \vec{Θ} ) ∝ {\prod }_{i} {\prod }_{j} N ( {W}_{i} \vert {\vec{Θ}}^{T} {\vec{x}}_{i} , {α}_{i}^{- 1} ) N ( {H}_{j} \vert {\vec{Θ}}^{T} {\overline{y}}_{j} , {β}_{j}^{- 1} ) \qquad Equation ( 2 )$$

where

$$N ( {W}_{i} \vert {\overline{Θ}}^{T} {\vec{x}}_{i} , {α}_{i}^{- 1} ) ∝ exp ( - \frac{{α}_{i}}{2} {( {\vec{Θ}}^{T} {\overline{x}}_{i} - {W}_{i} )}^{2} ) , \\ and$$

$$N ( {H}_{j} \vert {\vec{Θ}}^{T} {\overline{y}}_{j} , {β}_{j}^{- 1} ) ∝ exp ( - \frac{{β}_{j}}{2} {( {\overline{Θ}}^{T} {\overline{y}}_{j} - {H}_{j} )}^{2} ) ,$$

are normal probability distributions. The variables αᵢ⁻¹ and βⱼ⁻¹ are variances and Wᵢ and Hⱼ represent mean values for the distributions N(Wᵢ| Θ̅^{T} x̅ᵢ,αᵢ⁻¹) and N(Hⱼ| Θ̅^{T} y̅ⱼ,βⱼ⁻¹), respectively. Normal distributions can be used to characterize, at least approximately, the probability distribution of a variable that tends to cluster around the mean. In other words, variables close to the mean are more likely to occur than are variables farther from the mean. The normal distributions N(Wᵢ| Θ̅^{T} x̅ᵢ,αᵢ⁻¹) and N(Hⱼ| Θ̅^{T} y̅ⱼ,βⱼ⁻¹) characterize the probability distributions of the variables Wᵢ and Hⱼ about the mean values Θ̅^{T} x̅ᵢ and Θ̅^{T} y̅ⱼ, respectively.

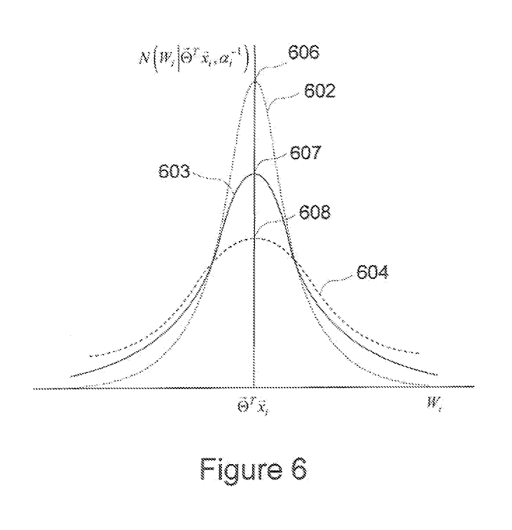

For the sake of discussion, consider just the distribution N(Wᵢ| Θ̅^{T} x̅ᵢ,αᵢ⁻¹). FIG. 6 shows exemplary plots of N(Wᵢ| Θ̅^{T} x̅ᵢ,αᵢ⁻¹) represented by curves 602-604, each curve representing the normal distribution N(Wᵢ| Θ̅^{T} x̅ᵢ,αᵢ⁻¹) for three different values of the variance αᵢ⁻¹. Comparing curves 602-604 reveals that curve 602 has the smallest variance and the narrowest distribution about Θ̅^{T} x̅ᵢ, curve 604 has the largest variance and the broadest distribution about Θ̅^{T} x̅ᵢ, and curve 603 has an intermediate variance and an intermediate distribution about Θ̅^{T} x̅ᵢ. In other words, the larger the variance αᵢ⁻¹ the broader the distribution N(Wᵢ| Θ̅^{T} x̅ᵢ,αᵢ⁻¹) about Θ̅^{T} x̅ᵢ, and the smaller the variance αᵢ⁻¹ the narrower the distribution N(Wᵢ| Θ̅^{T} x̅ᵢ,αᵢ⁻¹) about Θ̅^{T} x̅ᵢ. Note that all three curves 602-604 also have corresponding maxima 606-608 centered about Θ̅^{T} x̅ᵢ. Thus, when Θ̅^{T} x̅ᵢ equals Wᵢ (i.e. Θ̅^{T} x̅ᵢ−Wᵢ=0), the normal distribution N(Wᵢ| Θ̅^{T} x̅ᵢ,αᵢ⁻¹) is at a maximum value. The same observations can also be made for the normal distributions N(Hⱼ| Θ̅^{T} y̅ⱼ,βⱼ⁻¹).

The posterior probability P( Θ̅| W̅, H̅, x̅, y̅) can be maximized when the exponents of the normal distributions of equation (2) satisfy the following conditions:

Θ̅^{T} x̅ᵢ−Wᵢ=0 and Θ̅^{T} y̅ⱼ−Hⱼ=0

for all i and j. As described above, for a template, Wᵢ and Hⱼ are constants and the elements of x̅ᵢ and y̅ⱼ are constants. These conditions are satisfied by determining a parameter vector Θ̅^{MAP} that maximizes the posterior probability P( Θ̅| W̅, H̅, x̅, y̅). The parameter vector Θ̅^{MAP} can be determined by rewriting the posterior probability P( Θ̅| W̅, H̅, x̅, y̅) as a multi-variate normal distribution with a well-characterized mean and variance as follows:

$$P ( \vec{Θ} \vert \vec{W} , \overline{H} , \vec{x} , \overline{y} ) = N ( \vec{Θ} \vert {\overline{Θ}}^{MAP} , {( Λ + {\sum }_{i} {α}_{i} {\vec{x}}_{i} {\overline{x}}_{i}^{T} + {\sum }_{j} {β}_{j} {\overline{y}}_{j} {\overline{y}}_{j}^{T} )}^{- 1} )$$

The parameter vector Θ̅^{MAP} is the mean of the normal distribution characterization of the posterior probability P( Θ̅| W̅, H̅, x̅, y̅), and Θ̅ maximizes P( Θ̅| W̅, H̅, x̅, y̅) when Θ̅ equals Θ̅^{MAP}. Solving P( Θ̅| W̅, H̅, x̅, y̅) for Θ̅^{MAP} gives the following closed form expression:

$${\overline{Θ}}^{MAP} = {( Λ + {\sum }_{i} {α}_{i} {\vec{x}}_{i} {\overline{x}}_{i}^{T} + {\sum }_{j} {β}_{j} {\vec{y}}_{j} {\vec{y}}_{j}^{T} )}^{- 1} ( Λ \overline{Θ} + {\sum }_{i} {α}_{i} {W}_{i} {\vec{x}}_{i} + {\sum }_{j} {β}_{j} {H}_{j} {\overline{y}}_{j} )$$

The parameter vector Θ̅^{MAP} can also be rewritten in matrix from as follows:

Θ̅^{MAP}=A⁻¹ b̅

where

$$A = Λ + {\sum }_{i} {α}_{i} {\overline{x}}_{i} {\overline{x}}_{i}^{T} + {\sum }_{j} {β}_{j} {\overline{y}}_{j} {\vec{y}}_{j}^{T}$$

is a matrix and Λ⁻¹ is the inverse of A, and

$$\overline{b} = Λ \overline{Θ} + {\sum }_{i} {α}_{i} {W}_{i} {\vec{x}}_{i} + {\sum }_{j} {β}_{j} {H}_{j} {\overline{y}}_{j}$$

is a vector.

In summary, given a single page template and images to be placed in the image fields of the template, the parameters used to scale the images and white spaces of the template can be determined from the closed form equation for Θ̅^{MAP}.

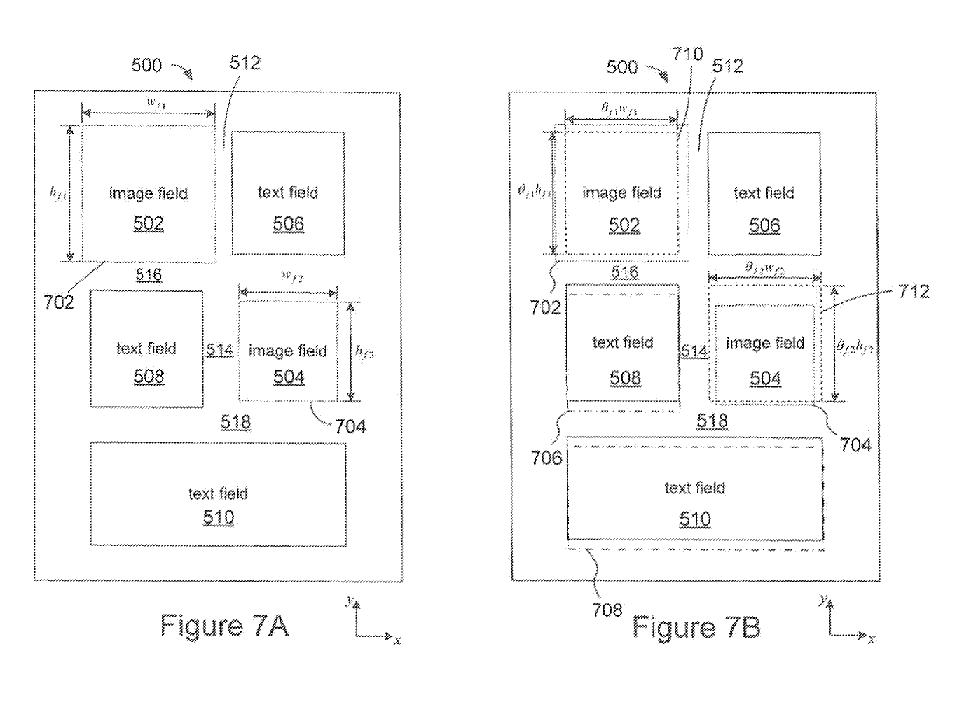

For a hypothetical example of applying the closed form parameter vector Θ̅^{MAP} to rescale image, white space, and margin dimensions of a template, consider the single page template 500, shown in FIG. 5A, which is reproduced in FIG. 7A in accordance with embodiments of the present invention. Dotted-line rectangle 702 represents boundaries of a first unscaled image to be placed in image field 502 with height h_{f1} and width w_{f1}, and dotted-line rectangle 704 represents boundaries of a second unscaled image to be placed in image field 504 with height h_{f2} and width w_{f2}. The dimensions of the text fields 506, 508 and 510 remain fixed and the document designer can adjust the font, character size, and line spacing accordingly in order to fit the appropriate text into each of the text fields 506, 508, and 510. Based on the vectors shown in FIG. 5B, the closed form expression for determining the parameters of the parameter vector Θ̅^{MAP} has the following general form:

$${\overline{Θ}}^{MAP} = {( Λ + {{\sum }_{i = 1}}^{2} {α}_{i} {\overline{x}}_{i} {\overline{x}}_{i}^{T} + {{\sum }_{j = 1}}^{2} {β}_{j} {\vec{y}}_{j} {\vec{y}}_{j}^{T} )}^{- 1} ( Λ \overline{Θ} + {{\sum }_{i = 1}}^{2} {α}_{i} {W}_{i} {\vec{x}}_{i} + {{\sum }_{j = 1}}^{2} {β}_{j} {H}_{j} {\vec{y}}_{j} )$$

where the document designer selects appropriate values for the variances α₁⁻¹, α₂⁻¹, β₁⁻¹, and β₂⁻¹. The constants W₁, W₂, H₁, and H₂ and the vectors x̅₁, x̅₂, y̅₁, and y̅₂ are determined as described above with reference to FIG. 5B. In certain embodiments, values for the matrix Λ and the vector Θ̅ can be determined by the linear relationships between the parameters of Θ̅^{MAP} represented in the matrix C described above. In other embodiments, values for the matrix Λ and the vector Θ̅ can be set by the document designer without regard to any relationship represented by the matrix C.

Once the parameters of the parameter vector Θ̅^{MAP} are determined using the closed form equation for Θ̅^{MAP}, the template is rendered by multiplying un-scaled dimensions of the images and widths of the white spaces by corresponding parameters of the parameter vector Θ̅^{MAP}.

FIG. 7B shows an example of a hypothetical rescaled version of the images and white spaces of the template 500 shown in FIG. 7A in accordance with embodiments of the present invention. Dot-dash-line boxes 706 and 708 represent the initial positions of the text fields 508 and 510, respectively, shown in FIG. 7A, prior to rescaling. After determining values for the elements of the vector Θ̅^{MAP}, the white spaces 516 and 518 are rescaled resulting in a repositioning of the text fields 508 and 510. The image with initial boundaries 702 is rescaled by the parameter θ_{f1} in order to obtain a rescaled image with boundaries represented by dashed-line box 710, and the image with initial boundaries 704 is rescaled by the parameter θ_{f2} in order to obtain a rescaled image with boundaries represented by dashed-line box 712.

The elements of the parameter vector Θ̅^{MAP} may also be subject to boundary conditions on the image fields and white space dimensions arising from the minimum width constraints for the margins. In other embodiments, in order to determine Θ̅^{MAP} subject to boundary conditions, the vectors x̅₁, x̅₂, y̅₁, and y̅₂, the variances α₁⁻¹, α₂⁻¹, β₁⁻¹, and β₂⁻¹, and the constants W₁, W₂, H₁, and H₂ are inserted into the linear equation A Θ̅^{MAP}= b̅, and the matrix equation solved numerically for the parameter vector Θ̅^{MAP} subject to the boundary conditions on the parameters of Θ̅^{MAP}. The matrix equation A Θ̅^{MAP}= b̅ can be solved using any well-known numerical method for solving matrix equations subject to boundary conditions on the vector Θ̅^{MAP}, such as the conjugate gradient method.

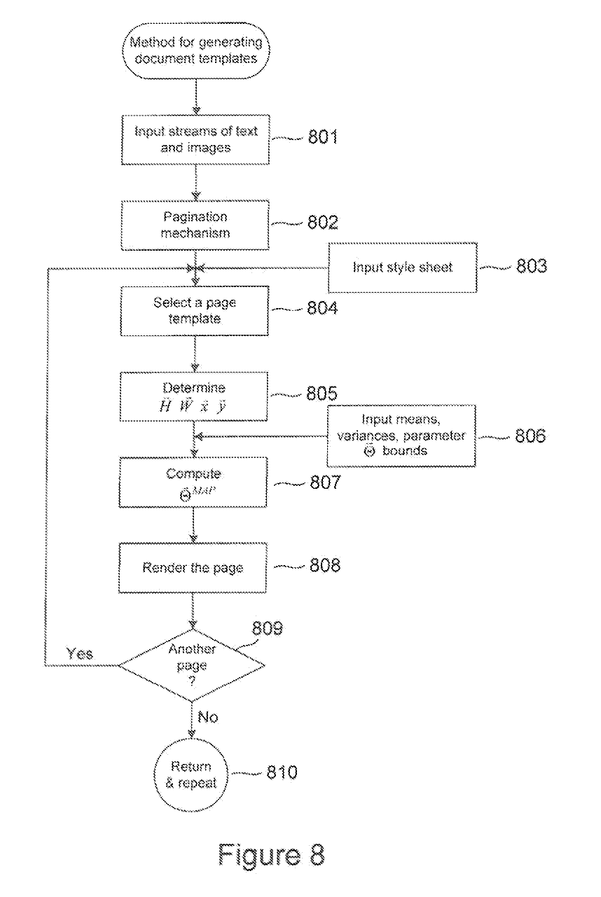

FIG. 8 shows a control-flow diagram of a method for generating document templates in accordance with embodiments of the present invention. Embodiments of the present invention are not limited to the specific order in which the following steps are presented. In other embodiments, the order in which the steps are performed can be changed without deviating from the scope of embodiments of the present invention described herein.

In step 801, streams of text and associated image data are input. In step 802, pagination is performed to determine the content for each page of the document. In step 803, a style sheet can selected for the templates of the document, as described in the subsection titled Template Parameters. The style sheet parameters can be used for each page of the document. In step 804, a template for a page of the document is selected, such as the exemplary document templates described about the subsection title Template Parameters. A template can be selected based on a number of different criteria. For example, the document designer can be presented with a variety of different templates to choose from and the document designer selects the template. In other embodiments, the template can be selected so that the text describing the contents of each image appear on the same page as the image or appear on the subsequent or preceding page of the document. In step 805, elements of the vectors W̅, H̅, x̅, and y̅ are determined as described in the subsection Template Parameters. In step 803, mean values corresponding to the widths Wᵢ and Hᵢ, the variances αᵢ⁻¹ and βⱼ⁻¹, and bounds for the parameters of the parameter vector Θ̅ are input. In step 807, the parameter vector Θ̅^{MAP} that maximizes the posterior probability P( Θ̅| W̅, H̅, x̅, y̅) is determined as described above. Elements of the parameter vector Θ̅^{MAP} can be determined by solving the matrix equation A Θ̅^{MAP}= b̅ for Θ̅^{MAP} using the conjugate gradient method or any other well-known matrix equation solvers where the elements of the vector Θ̅^{MAP} are subject to boundary conditions, such as minimum constraints placed on the margins. In step 808, once the parameter vector Θ̅^{MAP} is determined, rescaled dimensions of the images and widths of the white spaces can be obtained by multiplying dimensions of the template elements by the corresponding parameters of the parameter vector Θ̅^{MAP}. The template page can then be rendered with the images and text placed in appropriate image and text fields. The template page can be rendered by displaying the page on monitor, television set, or any other suitable display, or the template page can be rendered by printing the page on a sheet of paper of an appropriate size. In step 809, when another page of the document is to be prepared, steps 804, 805, 807, and 808 are repeated. Otherwise, the method proceeds to step 810 where a second document can be prepared by repeating steps 801-809.

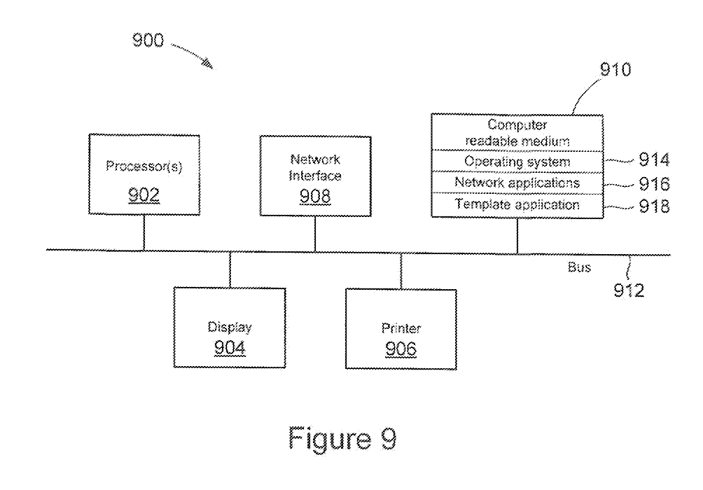

In general, the methods employed to generate a document described above can be implemented on a computing device, such as a desktop computer, a laptop, or any other suitable device configured to carrying out the processing steps of a computer program. FIG. 9 shows a schematic representation of a computing device 900 configured in accordance with embodiments of the present invention. The device 900 may include one or more processors 902, such as a central processing unit; one or more display devices 904, such as a monitor; a printer 906 printing the document; one or more network interfaces 908, such as a Local Area Network LAN, a wireless 802.11x LAN, a 3G mobile WAN or a WiMax WAN; and one or more computer-readable mediums 910. Each of these components is operatively coupled to one or more buses 912. For example, the bus 912 can be an EISA, a PCI, a USB, a FireWire, a NuBus, or a PDS.

The computer readable medium 910 can be any suitable medium that participates in providing instructions to the processor 902 for execution. For example, the computer readable medium 910 can be non-volatile media, such as firmware, an optical disk, a magnetic disk, or a magnetic disk drive; volatile media, such as memory; and transmission media, such as coaxial cables, copper wire, and fiber optics. The computer readable medium 910 can also store other software applications, including word processors, browsers, email, Instant Messaging, media players, and telephony software.

The computer-readable medium 910 may also store an operating system 914, such as Mac OS, MS Windows, Unix, or Linux; network applications 916; and a grating application 918. The operating system 914 can be multi-user, multiprocessing, multitasking, multithreading, real-time and the like. The operating system 914 can also perform basic tasks such as recognizing input from input devices, such as a keyboard, a keypad, or a mouse; sending output to the display 904 and the printer 906; keeping track of files and directories on medium 910; controlling peripheral devices, such as disk drives, printers, image capture device; and managing traffic on the one or more buses 912. The network applications 916 includes various components for establishing and maintaining network connections, such as software for implementing communication protocols including TCP/IP, HTTP, Ethernet, USB, and FireWire.

A template application 918 provides various software components for generating document templates, as described above. In certain embodiments, some or all of the processes performed by the application 918 can be integrated into the operating system 914. In certain embodiments, the processes can be at least partially implemented in digital electronic circuitry, or in computer hardware, firmware, software, or in any combination thereof.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

1. A method for generating a page template of a document using a computing device, the method comprising:
selecting a single page template (805), the template configured with an arrangement of one or more image fields and one or more text fields using the computing device;
determining constants presenting space available for displaying the one or more images and white spaces and vector representations of the one or more image and white space dimensions using the computing device (806);
computing a parameter vector that substantially maximizes a probabilistic characterization of the one or more image and white space dimensions using the computing device (807); and
rendering the page template using the computing device (808), the page presenting the one or more images and white spaces rescaled based on the parameter vector and in accordance with the one or more vector representations and the constants.

2. The method of claim 1 wherein selecting the page template further comprises presenting a variety of different templates to select from for each page of the document.

3. The method of claim 1 wherein selecting the page template further comprises selecting the template so that the text describing the contents of each image appear on the same page as the image or appear on the subsequent or preceding page of the document.

4. The method of claim 1 wherein determining constants presenting space available for displaying the one or more images and white spaces further comprises
determining constants corresponding to space available for displaying the one or more images and white spaces in a first direction; and
determining constants corresponding to space available for displaying the one or more images and white spaces in a second direction, the first direction orthogonal to the second direction.

5. The method of claim 1 wherein determining vector representations of the one or more image and white space dimensions further comprises
determining one or more vector representations of the dimensions of the one or more images and white spaces in a first direction; and
determining one or more vector representations of the dimensions of the one or more images and white spaces in a second direction orthogonal to the first direction using the computing device.

6. The method of claim 1 wherein computing the parameter vector further comprises solving a matrix equation A Θ̅^{MAP}= b̅ for the parameter vector Θ̅^{MAP} using the computing device, wherein
$$A = Λ + {\sum }_{i} {α}_{i} {\overline{x}}_{i} {\overline{x}}_{i}^{T} + {\sum }_{j} {β}_{j} {\overline{y}}_{j} {\overline{y}}_{j}^{T} , \\ and$$
$$\overline{b} = Λ \overline{Θ} + {\sum }_{i} {α}_{i} {W}_{i} {\overline{x}}_{i} + {\sum }_{j} {β}_{j} {H}_{j} {\vec{y}}_{j} , \\ and$$
wherein x̅ᵢ is a vector representing the dimensions of one or more of the images and white spaces in a first direction; y̅ⱼ is a vector representing the dimensions of one or more of the images and white spaces in a second direction orthogonal to the first direction, Wᵢ is a constant corresponding to space available for displaying the one or more of the images and white spaces in the first direction, Hⱼ is a constant corresponding to space available for displaying the one or more of the images and white spaces in the second direction, Λ=C^{T}Δ^{T}ΔC, Θ̅=Λ⁻¹C^{T}Δ^{T}Δ d̅, C is a matrix and d̅ is a vector representing linear relationships between the parameters of the parameter vector Θ̅^{MAP} and Δ is a covariance precision matrix, αᵢ is a constant determined by a document designer, and βⱼ is a constant determined by the document designer.

7. The method of claim 1 further comprising inputting streams of data corresponding to the one or more images and the text displaying in the text fields (801).

8. The method of claim 1 further comprising inputting a style sheet representing the document overall appearance (802).

9. The method of claim 1 further comprising inputting means, variances, bounds on the parameter vector (803).

10. The method of claim 1 further comprising inputting a parameterization scheme (804).

11. A computer-readable medium having instructions encoded thereon for enabling a processor to perform the operations of:
receiving a single page template data (805), the template configured with an arrangement of one or more image fields and one or more text fields;
determining constants presenting space available for displaying the one or more images and white spaces and vector representations of the one or more image and white space dimensions (806);
computing a parameter vector that substantially maximizes a probabilistic characterization of the one or more image and white space dimensions (807); and
rendering the page template (808), the page presenting the one or more images and white spaces rescaled based on the parameter vector and in accordance with the one or more vector representations and the constants.

12. The method of claim 11 wherein receiving the page template further comprises presenting a variety of different templates stored on the computer-readable medium on a display to enable a document designer to select the page template from.

13. The method of claim 11 wherein determining constants presenting space available for displaying the one or more images and white spaces further comprises
determining constants corresponding to space available for displaying the one or more images and white spaces in a first direction; and
determining constants corresponding to space available for displaying the one or more images and white spaces in a second direction, the first direction orthogonal to the second direction.

14. The method of claim 11 wherein determining vector representations of the one or more image and white space dimensions further comprises
determining one or more vector representations of the dimensions of the one or more images and white spaces in a first direction; and
determining one or more vector representations of the dimensions of the one or more images and white spaces in a second direction orthogonal to the first direction using the computing device.

15. The method of claim 11 wherein computing the parameter vector further comprises solving a matrix equation A Θ̅^{MAP}= b̅ for the parameter vector Θ̅^{MAP} using the computing device, wherein
$$A = Λ + {\sum }_{i} {α}_{i} {\overline{x}}_{i} {\overline{x}}_{i}^{T} + {\sum }_{j} {β}_{j} {\vec{y}}_{j} {\overline{y}}_{j}^{T} , \\ and$$
$$\overline{b} = Λ \overline{Θ} + {\sum }_{i} {α}_{i} {W}_{i} {\overline{x}}_{i} + {\sum }_{j} {β}_{j} {H}_{j} {\vec{y}}_{j} , \\ and$$
wherein x̅ᵢ is a vector representing the dimensions of one or more of the images and white spaces in a first direction; y̅ⱼ is a vector representing the dimensions of one or more of the images and white spaces in a second direction orthogonal to the first direction, Wᵢ is a constant corresponding to space available for displaying the one or more of the images and white spaces in the first direction, Hⱼ is a constant corresponding to space available for displaying the one or more of the images and white spaces in the second direction, Λ=C^{T}Δ^{T}ΔC, Θ̅=Λ⁻¹C^{T}Δ^{T}Δ d̅, C is a matrix and d̅ is a vector representing linear relationships between the parameters of the parameter vector Θ̅^{MAP} and Δ is a covariance precision matrix, αᵢ is a constant determined by a document designer, and βⱼ is a constant determined by the document designer.
